(19) United States
(12) Patent Application Publication
(10) Pub. No.: US 2025/0132398 A1
(43) Pub. Date: Apr. 24, 2025

(54) AQUEOUS IODINE-BASED BATTERY BASED ON MULTI-ELECTRON TRANSFER

(71) Applicant: DALIAN INSTITUTE OF CHEMICAL PHYSICS, CHINESE ACADEMY OF SCIENCES, Dalian (CN)

(72) Inventors: Xianfeng LI, Dalian (CN); Congxin XIE, Dalian (CN)

(73) Assignee: DALIAN INSTITUTE OF CHEMICAL PHYSICS, CHINESE ACADEMY OF SCIENCES, Dalian (CN)

(21) Appl. No.: 18/718,062

(22) PCT Filed: Jun. 10, 2022
(86) PCT No.: PCT/CN2022/098185

§ 371 Date: Jun. 10, 2024

(30) Foreign Application Priority Data
Dec. 8, 2021 (CN) 202111489735.1

(51) Int. Cl. H01M 10/36; H01M 4/02; H01M 4/133; H01M 50/414

(52) U.S. Cl. CPC H01M 10/36; H01M 4/133; H01M 50/414; H01M 2004/028; H01M 2300/0005

(57) ABSTRACT

An aqueous iodine-based battery based on multi-electron transfer includes a positive electrode, a negative electrode, a current collector, an electrolyte, and a separator. A porous carbon felt is used as the electrode material on both sides of the positive and negative electrodes, and a polymer film is used as the membrane material. Both the positive and negative electrolytes are stored in the porous carbon felt electrodes. Both the positive and negative electrolytes are acidic mixed solutions containing I⁻ and Cd⁻; during charging, I⁻ at the positive electrode is charged to Cd(IO₃)₂, which realizes a electrochemical reaction of six-electron transfer, and the negative electrode involves the deposition of Cd⁻ as a Cd metal; and the process is reversed during discharging. In order to improve the kinetics and reversibility of the multi-electron transfer process, additional additives are added to the solution to improve the electrochemical reversibility of the overall reaction.

### CROSS REFERENCE TO THE RELATED APPLICATIONS

This application is the national phase entry of International Application No. PCT/CN2022/098185, filed on Jun. 10, 2022, which is based upon and claims priority to Chinese Patent Application No. 202111489735.1, filed on Dec. 8, 2021, the entire contents of which are incorporated herein by reference.

### TECHNICAL FIELD

The present application relates to the field of battery, in particular to the field of multi-electron transfer aqueous iodine-based battery.

### BACKGROUND

The large-scale utilization of fossil energy has caused environmental pollution and energy crisis; therefore, the development and utilization of renewable energy is the key to solve the above problems. The promotion of electric vehicles is an important means to solve the fossil energy crisis. But at present, lithium-ion batteries are mainly use in electric vehicles; although the energy density of lithium-ion batteries is very high (about 300 Wh/L), but due to the use of organic electrolyte, it will bring about flammable and explosive problems. Aqueous batteries have good application prospects due to their high safety and power density. However, at present, the energy density of aqueous batteries is generally low, thus making it difficult to be used in the field of power batteries. The applicant has previously developed a multi-electron transfer aqueous iodine-based battery, in which I⁻ in the positive electrolyte can electrochemically react to generate I₂ under a strong acidic environment, and the I₂ in turn charges to IO₃⁻ to realize a six-electron transfer. And the high solubility of I⁻ enables a quantum leap in the energy density of the battery. However, the multi-electron transfer process faces serious electrochemical polarization problems. In the charging process, the electrochemical process of I₂ to generate IO₃⁻ needs to undergo a five-electron transfers and requires multiple H₂O to participate in the reaction, and the positive charge center of symmetric I₂ is difficult to be attacked by the oxygen of H₂O molecular, so that the charging reaction has a high polarization; for the discharging process, IO₃⁻ is structurally stable and has a large size, so that it is difficult to discharge directly on the electrode surface, and only indirect discharge can be achieved by oxidizing I⁻ in the solution to form I₂ by IO₃⁻. However, since the electrode potential of I₂/I⁻ (0.54 V vs. SHE) is much lower than that of IO₃⁻/I₂ (1.19 V vs. SHE), the discharging process is also highly polarized.

### SUMMARY

Iodine based secondary battery based on multi-electron transfer including a positive electrolyte and a negative electrolyte, where the positive electrolyte and the negative electrolyte both include a strong acidic aqueous solutions containing Cd²⁺ and I⁻, and a Br⁻ and/or Cl⁻ source additive, respectively.

A source of the I⁻ in the positive electrolyte and the negative electrolyte can be one or two or more of HI, KI, NaI, or CdI₂, respectively; a source of the Cd²⁺ can be one or two of CdI₂ or CdSO₄, respectively; and a supporting electrolyte in the electrolytes can be selected from H₂SO₄ to ensure a strong acidic environment.

In the positive electrolyte or negative electrolyte, a molar concentration of Cd²⁺ is from 0.5M to 3M, a molar concentration of I⁻ is from 1M to 6M, a molar ratio of Cd²⁺ to I⁻ is 1:2 to 1:1, and a molar concentration of H⁺ is from 3M to 12M, respectively; preferably, the molar ratio of Cd²⁺ to I⁻ is 1:2.

During charging process, IO⁻ generated from I⁻ at positive electrode can form a Cd(IO₃)₂ precipitate with Cd²⁺ in the solution, thus solving a problem of self-discharge of the battery due to the infiltration of oxidized charging product IO₃⁻.

Additives are added to the positive electrolyte and the negative electrolyte to reduce the polarization problem in the electrochemical process, respectively, and the additives are mainly for the purpose of introducing Br⁻ and/or Cl⁻. The Br⁻ source additive can be one or two or more of NaBr, KBr⁻ or HBr; the Cl⁻ source additive is one or two or more of NaCl, KCl or HCl; and a concentration of the introduced additives is from 1M to 3M.

A composition of the positive electrolyte and the negative electrolyte are as follows respectively:
HI used as an iodine-based active substance with a concentration of 1M to 6M (preferably 6M); HBr⁻ and/or HCl used as additive with a concentration of 1M to 3M (preferably 3M); H₂SO₄ used as a support electrolyte with a concentration of 1M to 3M (preferably 1M); CdSO₄ used as an active substance of Cd with a concentration of 1M to 3M (preferably 3M); or
HI used as an iodine-based active substance with a concentration of 1M to 6M (preferably 6M); one or two or more of NaBr, KBr, NaCl, and KCl used as additive with a concentration of 1M to 3M (preferably 3M); H₂SO₄ used as a support electrolyte with a concentration of 2M to 4M (preferably 2M); CdSO₄ used as an active substance of Cd with a concentration of 1M to 3M (preferably 3M); or
CdI₂ used as an active substance with a concentration of 0.5M to 3M (preferably 3M); HBr and/or HCl used as additive with a concentration of 1M to 3M (preferably 3M); H₂SO₄ used as a support electrolyte with a concentration of 2M to 4M (preferably 4M); or
CdI₂ used as an active substance with a concentration of 0.5M to 3M (preferably 3M); one or two or more of NaBr, KBr, NaCl, and KCl used as additive with a concentration of 1M to 3M (preferably 3M); H₂SO₄ used as a support electrolyte with a concentration of 3M to 5M (preferably 5M); or
NaI and/or KI used as an active substance with a concentration of 1M to 6M (preferably 6M); HBr⁻ and/or HCl used as additive with a concentration of 1M to 3M (preferably 3M); H₂SO₄ used as a support electrolyte with a concentration of 2M to 4M (preferably 4M); CdSO₄ used as an active substance of Cd with a concentration of 1M to 3M (preferably 3M); or
NaI and/or KI used as an active substance with a concentration of 1M to 6M (preferably 6M); one or two or more of NaBr, KBr, NaCl, and KCl used as additive with a concentration of 1M to 3M (preferably 3M); H₂SO₄ used as a support electrolyte with a concentration of 3M to 5M (preferably 5M); CdSO₄ used as an active substance of Cd with a concentration of 1M to 3M (preferably 3M).

The battery includes a positive electrode, a negative electrode, a membrane material, and the electrolyte, where the electrolyte of positive and negative are strong acidic aqueous solutions containing Cd²⁺ and I⁻, and the additive need to be introduced into the electrolyte to improve the kinetics and reversibility of an electrochemical reaction process; the membrane material of the battery is a polymer material, which is one or more of polyethersulfone (PES), polyvinylchloride (PVC), polysulfone (PSF), polyethylene (PE), or Nafion, and preferably Nafion resin.

The battery includes single cell or stacks; a structure of the single cell includes a positive terminal plate, a positive current collector, a positive carbon felt electrode filled with the positive electrolyte, a separator, a negative carbon felt electrode filled with the negative electrolyte, a negative current collector, and a negative terminal plate stacked in a sequential; the stack is composed of two or more single cell circuits in series and/or parallel.

When the battery is charged, I⁻ in the positive electrolyte generates I₂ at the porous electrode and then continues to be charged to generate iodine interhalogen compounds such as IBr/ICl, and then continues to be charged and eventually generates IO₃⁻ and forms Cd(IO₃)₂ with Cd²⁺; Cd²⁺ in the negative electrolyte is reduced to metal Cd. For the discharging process, the discharging process at the positive electrode is an indirect discharge of Cd(IO₃)₂ through a chemical-oxidation-electrochemical reaction and finally discharge to generate I⁻; while the discharging reaction at the negative electrode is the generation of Cd²⁺ from metal Cd.

Beneficial effects that can be produced by the present application include:
The present invention introduces other halogen ions (Br⁻ or Cl⁻) as additives in the electrolyte, which can well improve the electrochemical activity and reversibility of the electrolyte. The formation of interhalogen compounds (IBr/ICI) between halogens with different electronegativities (I₂ and Br₂ or I₂ and Cl₂) facilitates the attack of water molecules on the positive charge centers, and thus reducing the polarization of the charging. For example, Cl⁻ or Br⁻ is introduced into the solution as an additive, and I² is able to generate interhalogen compounds, such as ICl or IBr, with Br₂ or Cl₂ during the electrochemical reaction; compared to the symmetric molecule I₂, the positive charge of ICl or IBr⁻ is mainly concentrated on iodine atoms, and therefore, during the charging process, the oxygen atoms of H₂O are more likely to attack them thereby favoring the generation of IO₃, and the generated IO₃⁻ can form Cd(IO₃)₂ with Cd₂, thus avoiding self-discharge caused by the infiltration of IO₃⁻ and reducing the electrochemical polarization of charging. For the discharging process, IO₃⁻ chemically oxidizes other halogen ions such as Cl⁻/Br⁻ to from IBr, Br₂ or ICl, Cl₂, and in turn, indirect discharge can be realized by the reduction of IBr, Br₂ or ICl, Cl₂ on the electrode surface. In addition, halogens with higher electronegativity have higher electrode potentials, e.g., the electrode potential of Br₂/Br⁻ is about 1.08 V, which is slightly lower than the electrode potential of I₂/IO₃⁻ of 1.19 V. Therefore, the IO₃⁻ can easily oxidize Br⁻ to monomeric bromine, and the potential difference between the two is relatively small (much smaller than the potential difference between IO₃⁻/I₂ (1.19V vs. SHE) and I₂/I⁻ (0.54 V vs. SHE)), which can effectively reduce the discharge polarization of the battery. The system realizes a reversible six-electron transfer reaction of I⁻/IO₃⁻ in a strong acidic medium, which leads to an extremely high energy density by increasing the electron transfer number and combining it with a high concentration of electrolyte.

### BRIEF DESCRIPTION OF THE DRAWINGS

FIG. 1 is a structure diagram of a multi-electron transfer aqueous iodine-based battery system.

FIGS. 2A-2B show the charge/discharge curves and cycle performance of the assembled battery of Example 1. The composition of the electrolytes is 0.5M CdI₂+3M H₂SO₄+1M HBr. The working current density of the battery is 80 mA/cm² and the membrane material is Nafion 115 membrane. The energy density of the battery at a current density of 80 mA/cm² is more than 220 Wh/L, and the energy efficiency is more than 77%; and the battery can run stably for more than 500 cycles with an energy density of 100 Wh/L. The structure of the battery mainly includes: a positive terminal plate, a positive current collector, a positive electrode, a separator, a negative electrode, a negative current collector, and a negative terminal plate. The test conditions of the battery are as follows: charging cut-off condition is double cut-off of voltage and capacity, and discharging cut-off condition is 0.1 V voltage. The charging and discharging processes of the battery are constant current charging and discharging.

FIGS. 3A-3B show the charge/discharge curves and cycle performance of the assembled battery of Example 2. The composition of the electrolytes is 1M CdI₂+3M H₂SO₄+2M HBr. The working current density of the battery is 80 mA/cm² and the membrane material is Nafion 115 membrane. The energy density of the battery at a current density of 80 mA/cm² is more than 350 Wh/L, and the energy efficiency is more than 77%; and the battery can run stably for more than 400 cycles with an energy density of 220 Wh/L.

FIG. 4 shows the charge/discharge curves and cycle performance of the assembled battery of Example 3. The composition of the electrolytes is 3M CdI₂+3M H₂SO₄+3M HBr⁻ and the membrane material is Nafion 115 membrane. The battery can achieve an energy density of over 1100 Wh/L at 40 mA/cm² and an energy efficiency of over 75%.

FIGS. 5A-5B show the charge/discharge curves and cycle performance of the assembled battery of Example 4. The composition of the electrolytes is 3M HI+1.5M CdSO₄+3M H₂SO₄+3M HBr, and the membrane material is Nafion 115 membrane. The battery can achieve an energy density of over 490 Wh/L at 80 mA/cm² and an energy efficiency of over 76%; and the battery can run stably for more than 120 cycles with an energy density of 320 Wh/L.

FIG. 6 shows the charge/discharge curves of the assembled battery of Example 5. The composition of the electrolytes is 1M CdI₂+3M H₂SO₄+2M NaBr⁻ and the membrane material is Nafion 115 membrane. The battery can achieve an energy density of over 350 Wh/L at 80 mA/cm² and an energy efficiency of over 76%.

FIG. 7 shows a graph of the performance of the assembled battery of Example 6. The composition of the electrolytes is 1M CdI₂+3M H₂SO₄+2M NaCl, the additive was changed from Br⁻ to Cl⁻, and the membrane material is Nafion 115 membrane. The battery can achieve an energy density of over 340 Wh/L at 80 mA/cm² and an energy efficiency of over 76%.

FIG. 8 shows a graph of the performance of the assembled battery of Example 7. The composition of the electrolytes is 1M CdI₂+3M H₂SO₄+2M HCl, and the membrane material is Nafion 115 membrane. The battery can achieve an energy density of over 345 Wh/L at 80 mA/cm² and an energy efficiency of over 76%.

FIG. 9 shows a graph of performance of the assembled battery of Preferred Example 1. The composition of the electrolytes is 6M HI+3M HBr+1M H₂SO₄+3M CdSO₄, and the membrane material is Nafion 115 membrane. The battery can achieve an energy density of over 1050 Wh/L at 80 mA/cm² and an energy efficiency of over 74%.

FIG. 10 shows a graph of performance of the assembled battery of Preferred Example 2. The composition of the electrolytes is 6M HI+3M KCl+2M H₂SO₄+3M CdSO₄, and the membrane material is Nafion 115 membrane. The battery can achieve an energy density of over 1020 Wh/L at 80 mA/cm² and an energy efficiency of over 75%.

FIG. 11 shows a graph of performance of the assembled battery of Preferred Example 3. The composition of the electrolytes is 6M NaI+3M HBr+4M H₂SO₄+3M CdSO₄, and the membrane material is Nafion 115 membrane. The battery can achieve an energy density of over 1060 Wh/L at 80 mA/cm² and an energy efficiency of over 74%.

FIG. 12 shows a graph of performance of the assembled battery of Preferred Example 4. The composition of the electrolytes is 6M NaI+3M NaBr+5M H₂SO₄+3M CdSO₄, and the membrane material is Nafion 115 membrane. The battery can achieve an energy density of over 1045 Wh/L at 80 mA/cm² and an energy efficiency of over 76%.

FIG. 13 shows a graph of performance of the assembled battery of Preferred Example 5. The composition of the electrolytes is 6M KI+3M HBr+4M H₂SO₄+3M CdSO₄, and the membrane material is Nafion 115 membrane. The battery can achieve an energy density of over 1074 Wh/L at 80 mA/cm² and an energy efficiency of over 74%.

FIG. 14 shows a graph of performance of the assembled battery of Preferred Example 6. The composition of the electrolytes is 6M KI+3M HBr+4M H₂SO₄+3M CdSO₄, and the membrane material is Nafion 115 membrane. The battery can achieve an energy density of over 1022 Wh/L at 80 mA/cm² and an energy efficiency of over 74%.

FIG. 15 shows the performance test chart of the multi-electron transfer iodine-based battery assembled in Comparative Example 1. The composition of the electrolytes is 0.5M CdI₂+3M H₂SO₄, the working current density of the battery is 80 mA/cm² and the membrane material is Nafion 115 membrane. However, the polarization of the battery is very severe, with an energy efficiency of only 57%, and due to the influence of polarization, the energy density of the battery is relatively low, only 114 Wh/L.

FIG. 16 shows the performance test chart of the multi-electron transfer iodine-based battery assembled in Comparative Example 2. The composition of the electrolytes is 0.5M CdI₂+3M H₂SO₄+0.1M HBr, the working current density of the battery is 80 mA/cm² and the membrane material is Nafion 115 membrane. Due to the low concentration of HBr, the polarization of the battery is severe, and the energy efficiency is only 54%, and the energy density of the battery is limited, only 104 Wh/L.

FIG. 17 shows the performance test chart of the battery assembled in Comparative Example 3. The composition of the electrolytes is 1M HI+3M H₂SO₄+1M HBr+0.2M CdSO₄. The working current density of the battery is 80 mA/cm² and the membrane material is Nafion 115 membrane. Due to Cd²⁺:I⁻=1:5 in the solution, the generated IO₃⁻ cannot form Cd(IO₃)₂ precipitate with Cd²⁺, resulting in severe electrolyte crossover. Therefore, the Coulombic efficiency of the battery is relatively low, with an energy efficiency of nearly 60% and an energy density of only about 103 Wh/L.

FIG. 18 shows the performance test chart of the battery assembled in Comparative Example 4. The composition of the electrolytes is 0.5M CdI₂+1M HBr. The working current density of the battery is 80 mA/cm² and the membrane material is Nafion 115 membrane. Although HBr⁻ is added as an additive, the low concentration of H′ in the solution will affect the chemical reaction rate of IO₃⁻ oxidizing Br⁻, ultimately affecting the energy efficiency of the battery. The test results show that the energy efficiency of the battery at 80 mA/cm² is only 65% and the energy density is lower than 150 Wh/L.

FIG. 19 shows the performance test chart of the battery assembled in Comparative Example 5. The composition of the electrolytes is 0.5M CdI₂+0.5M H₂SO₄+1M HBr. The working current density of the battery is 80 mA/cm² and the membrane material is Nafion 115 membrane. Similar to Comparative Example 4, although HBr⁻ is added as an additive and some H₂SO₄ is added as a supporting electrolyte, the H⁺ concentration is still low, so the reaction rate of IO₃⁻ oxidizing Br is slow, and as a result, the polarization of the battery is still severe and the efficiency of the battery is only 70%.

FIG. 20 shows the performance test chart of the battery assembled in Comparative Example 6. The composition of the electrolytes is 0.1M CdI₂+3M H₂SO₄+1M HBr. The working current density of the battery is 80 mA/cm² and the membrane material is Nafion 115 membrane. However, in this electrolyte system, due to the low concentration of CdI₂, less IO₃⁻ is generated, for which it is difficult to chemically react with Br⁻ during discharging to achieve indirect discharge. Therefore, the polarization of the battery is still relatively high. The test results show that at 80 mA/cm², the energy efficiency of the battery is only 64%.

FIG. 21 shows the performance test chart of the battery assembled in Comparative Example 7. The composition of the electrolytes is 0.5M CdI₂+3M H₂SO₄+1M HBr. The working current density of the battery is 80 mA/cm² and the membrane material is PE porous film. Compared to Nafion 115 membrane, PE porous membrane has a weaker barrier ability to the positive electrode charging products, resulting in severe infiltration of the positive electrolyte and low Coulombic efficiency of the battery. The test results of the battery indicate that the energy density of the battery is only 52%.

FIG. 22 shows the performance test chart of the battery assembled in Comparative Example 8. The composition of the electrolytes is 1M HI+3M H₂SO₄+1M TiOSO⁴. The working current density of the battery is 80 mA/cm² and the membrane material is Nafion 115 membrane. Compared to the Cd²⁺/Cd negative electrode, the Ti³⁺/Ti⁴⁺ electrode used as the negative electrode of the battery has very poor performance. This is mainly due to the low activity of TiO(IO₃)₂ generated by IO₃⁻ and TiO²⁺, making it difficult to oxidize Br⁻, and the energy efficiency of the battery is only 32%.

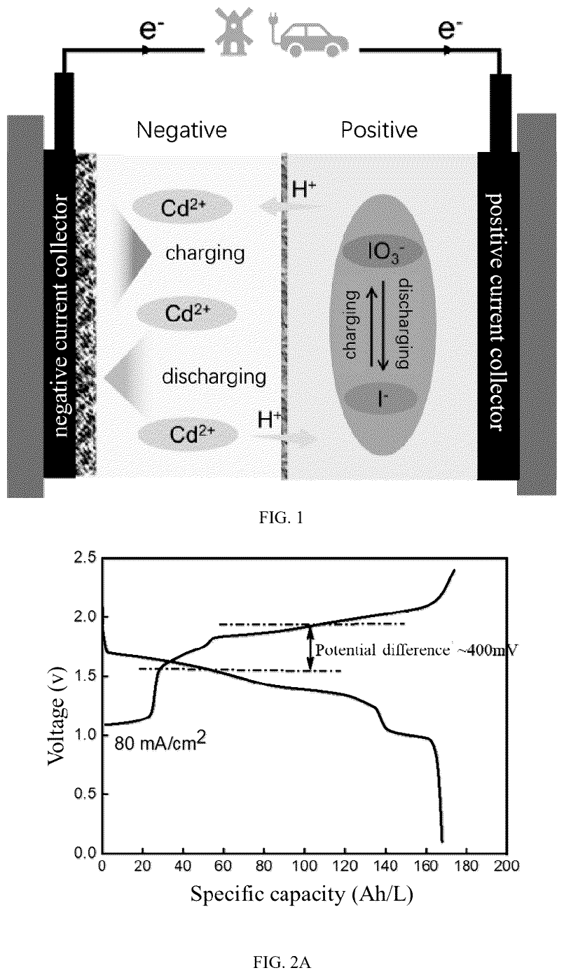

### DETAILED DESCRIPTION OF THE EMBODIMENTS

Performance testing of a multi-electron transfer iodine-based aqueous battery was conducted with a charging current density of 80 mA/cm², one or both of a battery charging cut-off voltage of 2.4 V or a specific capacity, and a discharge cut-off voltage of 0.1 V. The carbon felts on both sides of the positive and negative electrodes of the battery were 1 mm, with a surface area of 48 cm², and the volume of electrolyte on the positive side of the battery was 5 mL, and on the negative side of the battery was 15 mL, where the electrolyte on both sides of the battery was adsorbed inside the porous carbon felts. The membrane material for the battery is Nafion 115 membrane. The positive and negative electrolytes are the same.

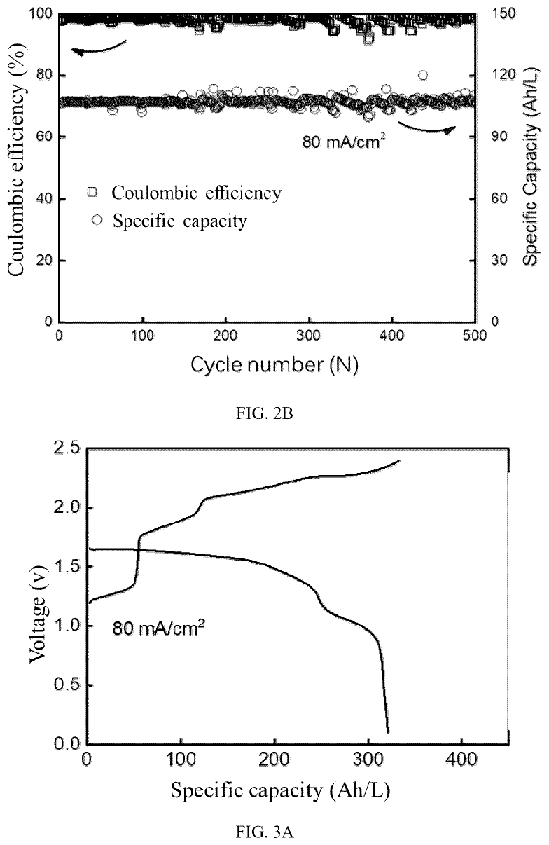

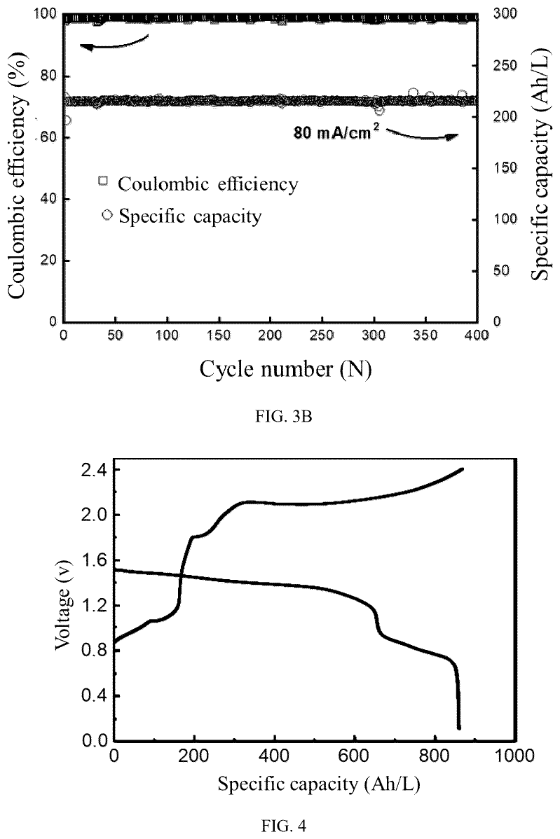

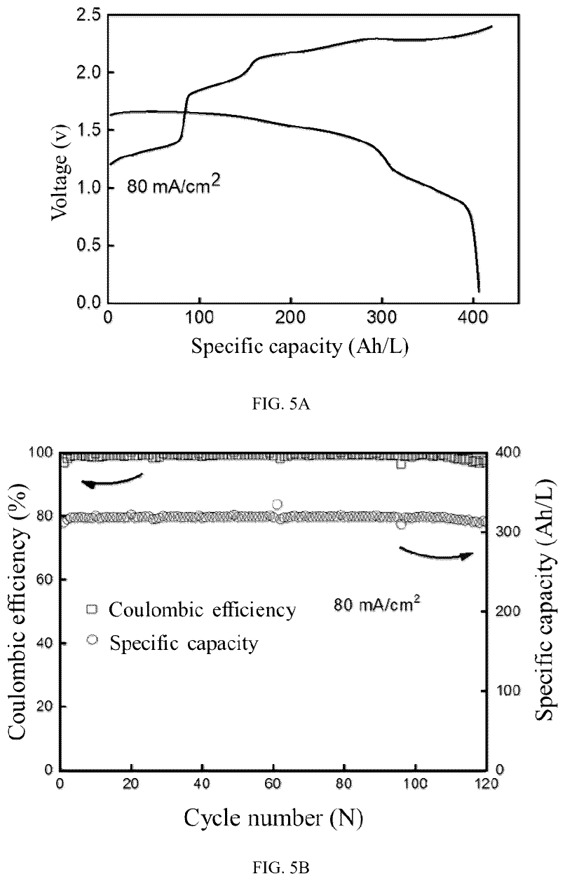

FIGS. 2A-5B (Examples 1-4) show the charging and discharging curves and cycle performance tests of the battery under the optimal conditions; as the electrolyte concentration increases, the energy density of the battery rises to 1100 Wh/L from 220 Wh/L at 1M. In addition, by maintaining a constant capacity of four electrons for charging and discharging, the battery can operate stably for a maximum of more than 500 cycles.

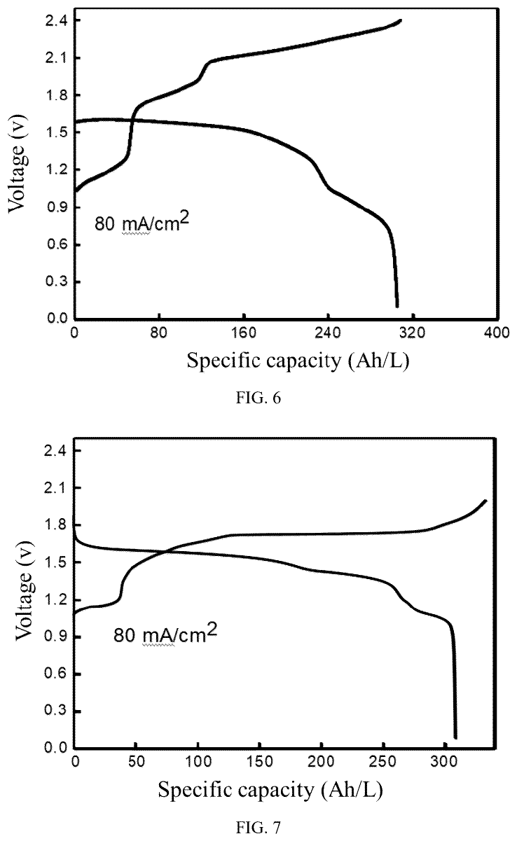

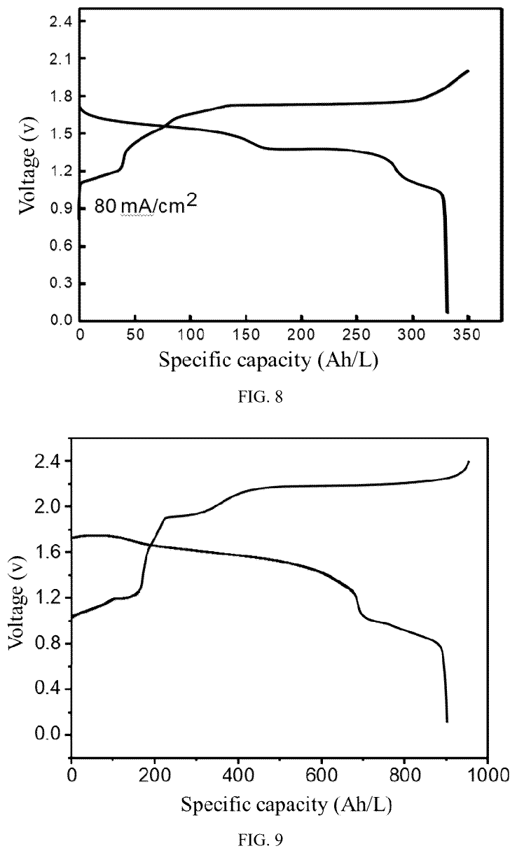

Compared to electrolytes with HBr⁻ as an additive, replacing HBr⁻ in the solution with NaBr, HCl, or NaCl (corresponding to FIGS. 6-8 in Examples 5-7) can also achieve higher electrochemical activity. This is mainly due to the formation of iodine interhalogen compounds IBr/ICl during the charging process, which can also reduce charging polarization. For the discharging process, IO₃⁻ can oxidize Br/Cl⁻ to achieve indirect discharge and increase the discharge voltage of the battery. Therefore, the energy efficiency of the electrolyte system with the above additives can also achieve an energy efficiency of >75%.

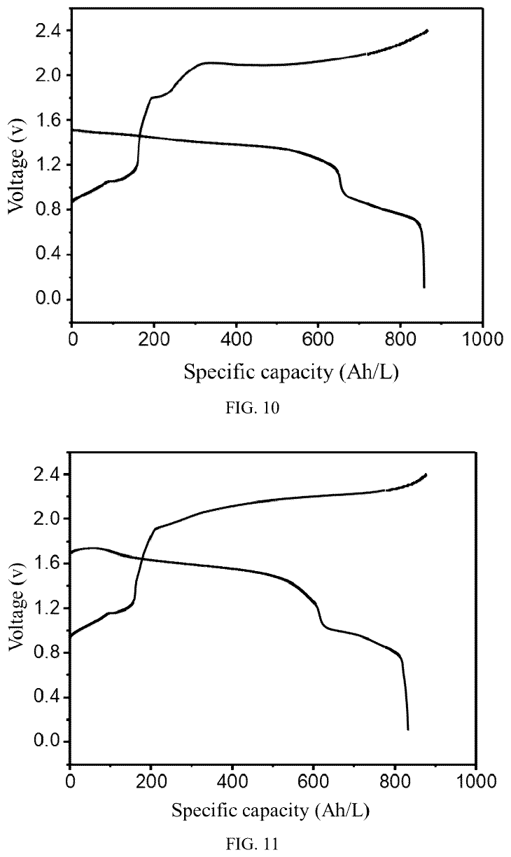

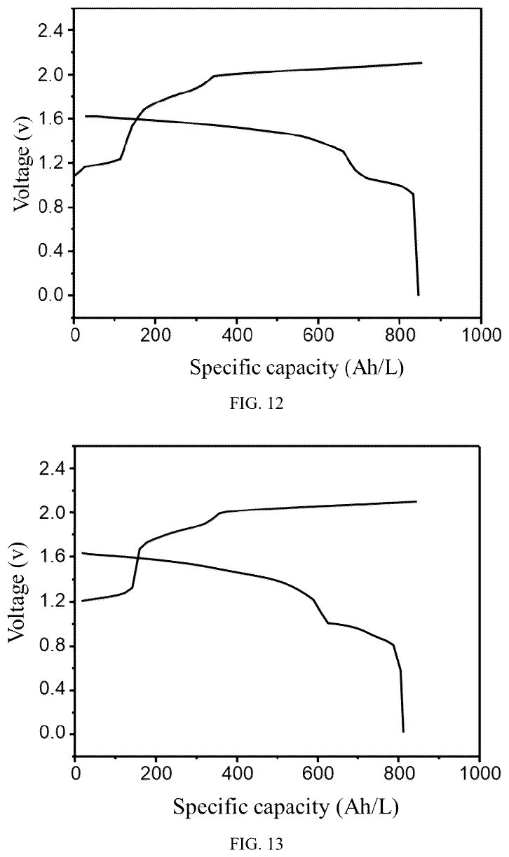

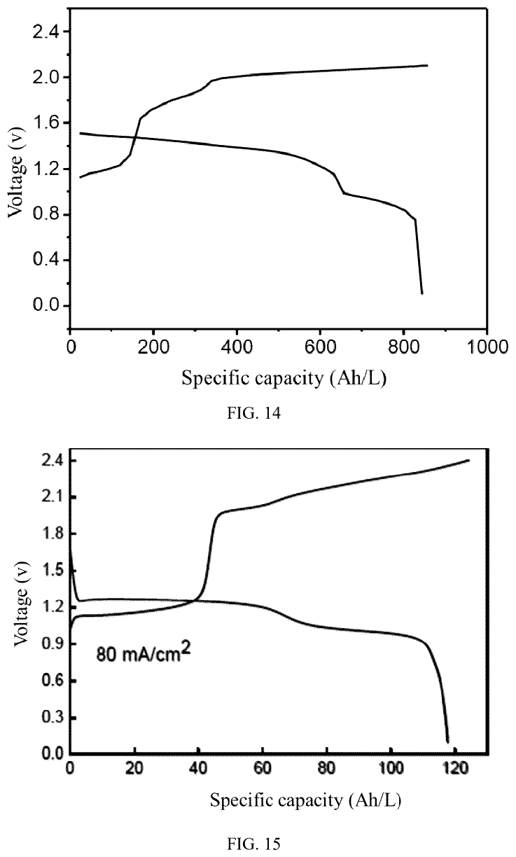

Increasing the concentration of the electrolyte to 6M (the most preferred electrolyte composition, Preferred Examples 1-6, corresponding to FIGS. 9-14), the energy density of the battery is about 1100 Wh/L, and the efficiency exceeds 74%. This indicates that the most preferred electrolyte has a significant advantage in terms of energy density.

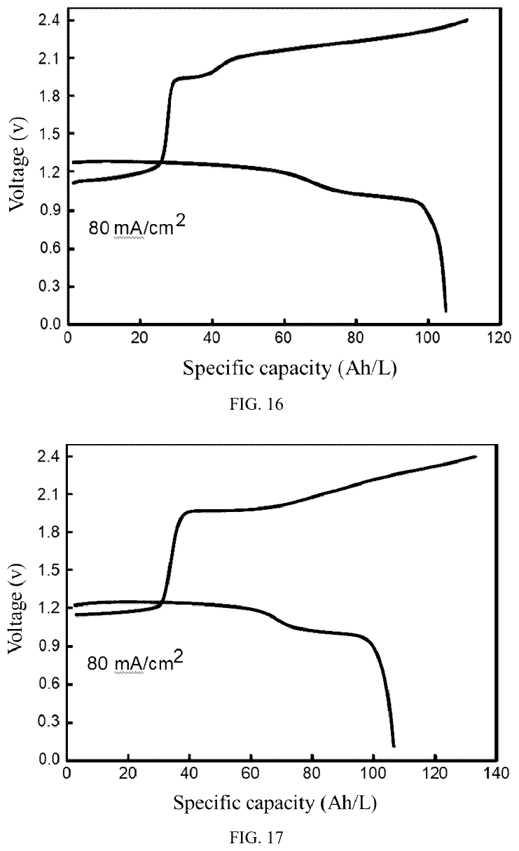

Compared to electrolyte systems with additives, electrolytes with lower additive concentrations or without additives exhibit severe polarization, the performance of the battery is lower (Comparative Examples 1-2; FIGS. 15-16), and the energy efficiency of the battery is less than 60%.

Compared with the electrolyte systems with a higher concentration of Cd²⁺, the low concentration of Cd²⁺ makes it difficult to completely precipitate with IO₃⁻ in the solution; the self-discharge of the battery is serious, the performance of the battery is low (Comparative Example 3; FIG. 17), and the energy efficiency of the battery is lower than 60%.

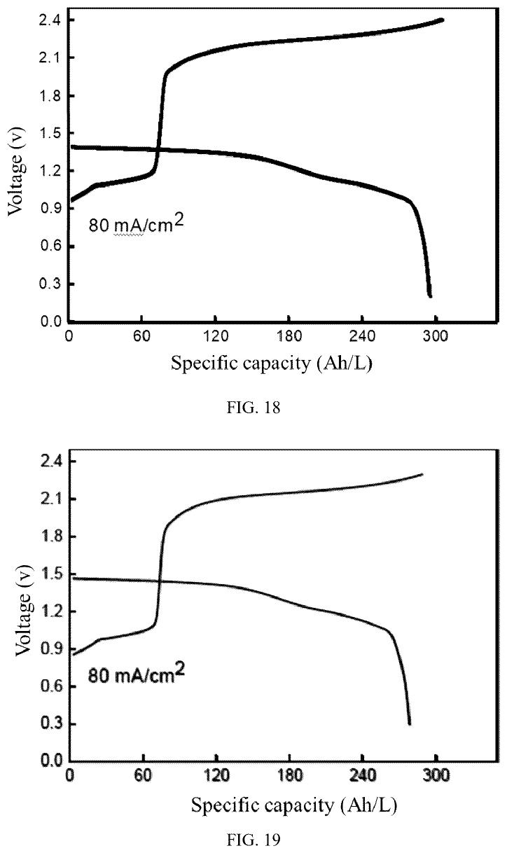

Reducing the concentration of H⁺ in the solution will also decrease the performance of the battery, mainly because the reduction in the concentration of H⁺ causes a decrease in the oxidizability of IO₃⁻ in the electrolyte, which decrease the rate of oxidizing Br⁻ in the solution (Comparative Examples 4-5; FIGS. 18-19).

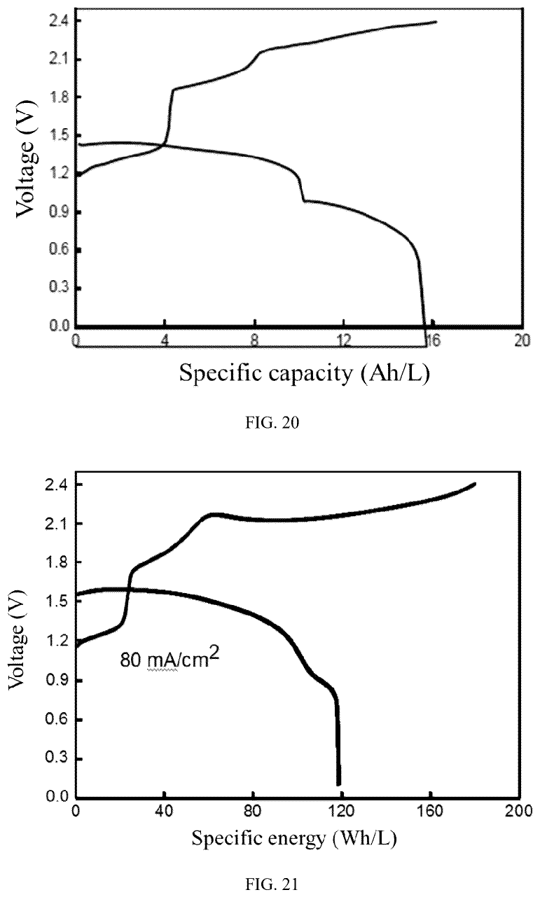

By reducing the concentration of I⁻ in the solution, the efficiency of the battery also significantly decreases. This is mainly because as the concentration of I⁻ decreases, the rate of IO₃⁻ chemical oxidizing Br⁻ or Cl⁻ in the electrolyte during charging and discharging is limited. Therefore, the energy efficiency of the battery is only about 64% (Comparative Example 6; FIG. 20).

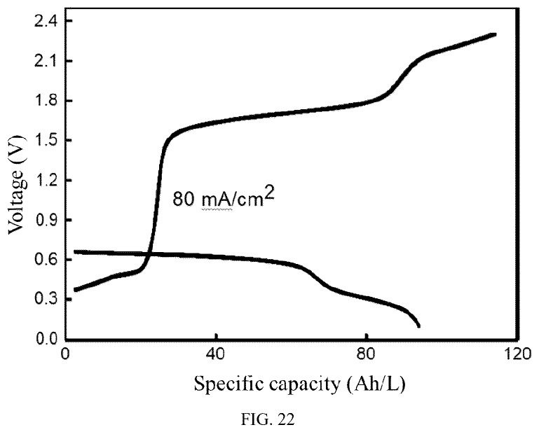

Replacing Nafion 115 membrane with PE polyolefin porous membrane resulted in a low Coulombic efficiency of the battery due to severe electrolyte crossover (Comparative Example 7; FIG. 21).

By replacing the Cd²⁺/Cd negative electrode of the battery with Ti³⁺/Ti⁴⁺, the IO₃⁻ generated from I⁻ oxidation generate TiO(IO₃)₂ with TiO²⁺. Due to the slow rate of chemical oxidation of Br⁻ or Cl⁻ by TiO(IO₃)₂, the efficiency and energy density of the battery are low (Comparative Example 8; FIG. 22).

TABLE 1
Examples of iodine based multi-electron transfer battery system

| | | | | | Energy |
|---|---|---|---|---|---|
| | Composition of electrolyte | Energy density | Current density | Membrane | efficiency |
| Examples | (mol/L) | (Wh/L) | (mA/cm²) | material | EE(%) |
| 1 | 0.5M CdI₂, 1M HBr, 3M H₂SO₄ | 220 | 80 | Nafion115 | 78% |
| 2 | 1M CdI₂, 2M HBr, 3M H₂SO₄ | 350 | 80 | Nafion115 | 77% |
| 3 | 3M CdI₂, 3M HBr, 3M H₂SO₄ | 1100 | 40 | Nafion115 | 75% |
| 4 | 3M HI, 1.5M CdSO₄, 3M | 490 | 80 | Nafion115 | 76% |
| | HBr, 3M H₂SO₄ | | | | |
| 5 | 1M CdI₂, 2M NaBr, 3M H₂SO₄ | 350 | 80 | Nafion115 | 76% |
| 6 | 1M CdI₂, 2M NaCl, 3M H₂SO₄ | 340 | 80 | Nafion115 | 76% |
| 7 | 1M CdI₂, 2M HCl, 3M H₂SO₄ | 345 | 80 | Nafion115 | 76% |

TABLE 2
Preferred examples of iodine based multi-electron transfer battery system

| | | | Working | | Energy |
|---|---|---|---|---|---|
| Preferred | Composition of electrolyte | Energy density | current density | Membrane | efficiency |
| examples | (mol/L) | (Wh/L) | (mA/cm²) | material | EE(%) |
| 1 | 6M HI, 3M HBr, 1M H₂SO₄, | 1050 | 80 | Nafion115 | 74% |
| | 3M CdSO₄ | | | | |
| 2 | 6M HI, 3M KCl, 2M H₂SO₄, | 1020 | 80 | Nafion115 | 75% |
| | 3M CdSO₄ | | | | |
| 3 | 6M NaI, 3M HBr, 4M H₂SO₄, | 1060 | 80 | Nafion115 | 74% |
| | 3M CdSO₄ | | | | |
| 4 | 6M NaI, 3M NaBr, 5M H₂SO₄, | 1045 | 80 | Nafion115 | 76% |
| | 3M CdSO₄ | | | | |
| 5 | 6M KI, 3M HBr, 4M H₂SO₄, | 1074 | 80 | Nafion115 | 74% |
| | 3M CdSO₄ | | | | |
| 6 | 6M KI, 3M HBr, 4M H₂SO₄, | 1022 | 80 | Nafion115 | 74% |
| | 3M CdSO₄ | | | | |

TABLE 3
Comparative examples of iodine based multi-electron transfer battery system

| | | | Working | | |
|---|---|---|---|---|---|
| | | Energy | current | | Energy |
| Comparative | Composition of electrolyte | density | density | Membrane | efficiency |
| examples | (mol/L) | (Wh/L) | (mA/cm²) | material | EE(%) |
| 1 | 0.5M CdI₂, 3M H₂SO₄ | 114 | 80 | Nafion115 | 57% |
| 2 | 0.5M CdI₂, 3M H₂SO₄, 0.1M HBr | 104 | 80 | Nafion115 | 54% |
| 3 | 1M HI, 3M H₂SO₄, 1M HBr, | 103 | 80 | Nafion115 | 60% |
| | 0.2M CdSO₄ | | | | |
| 4 | 0.5M CdI₂, 1M HBr | 150 | 80 | Nafion115 | 65% |
| 5 | 0.5M CdI₂, 1M HBr, 0.5M H₂SO₄ | 170 | 80 | Nafion115 | 70% |
| 6 | 0.1M CdI₂, 1M HBr, 3M H₂SO₄ | 15 | 80 | Nafion115 | 64% |
| 7 | 0.5M CdI₂, 1M HBr, 3M H₂SO₄ | 150 | 80 | PE porous | 52% |
| | | | | film | |
| 8 | 1M HI, 3M H₂SO₄, 1M TiOSO₄ | 50 | 80 | Nafion115 | 32% |

The above embodiments are merely some of the embodiments of the present application, and do not limit the present application in any form. Although the present application is disclosed above with the preferred embodiments, the present application is not limited thereto. Some changes or modifications made by any technical personnel familiar with the profession using the technical content disclosed above without departing from the scope of the technical solutions of the present application are equivalent to equivalent implementation cases and fall within the scope of the technical solutions.

What is claimed is:

1. An aqueous iodine-based battery based on a multi-electron transfer comprising a positive electrolyte and a negative electrolyte, wherein each of the positive electrolyte and the negative electrolyte comprises a strong acidic aqueous solution containing Cd²⁺ and I⁻, and a Br⁻ and/or Cl⁻ source additive.

2. The aqueous iodine-based battery based on the multi-electron transfer according to claim 1, wherein a source of the I⁻ in the positive electrolyte and the negative electrolyte is at least one of HI, KI, NaI, or CdI₂, respectively; a source of the Cd²⁺ is at least one of CdI₂ or CdSO₄, respectively; and a supporting electrolyte in the positive electrolyte and the negative electrolytes is selected from H₂SO₄ to ensure a strong acidic environment.

3. The aqueous iodine-based battery based on the multi-electron transfer according to claim 1, wherein in the positive electrolyte or the negative electrolyte, a molar concentration of the Cd²⁺ is from 0.5M to 3M, a molar concentration of the I⁻ is from 1M to 6M, a molar ratio of the Cd²⁺ to the I⁻ is 1:2 to 1:1, and a molar concentration of H⁺ is from 3M to 12M, respectively.

4. The aqueous iodine-based battery based on the multi-electron transfer according to claim 1, wherein during a charging process, IO generated from the I⁻ at a positive electrode forms a Cd(IO₃)₂ precipitate with the Cd²⁺ in the strong acidic aqueous solution, to solve a problem of a self-discharge of the aqueous iodine-based battery based on the multi-electron transfer due to an infiltration of an oxidized charging product IO₃⁻.

5. The aqueous iodine-based battery based on the multi-electron transfer according to claim 1, wherein the Br⁻ source additive is at least one of NaBr, KBr, or HBr; the Cl⁻ source additive is at least one of NaCl, KCl, or HCl; and a concentration of an introduced additive is from 1M to 3M.

6. The aqueous iodine-based battery based on the multi-electron transfer according to claim 1, wherein a composition of the positive electrolyte and the negative electrolyte are as follows respectively:
HI used as an iodine-based active substance with a concentration of 1M to 6M; HBr⁻ and/or HCl used as the Br⁻ and/or Cl⁻ source additive with a concentration of 1M to 3M; H₂SO₄ used as a support electrolyte with a concentration of 1M to 3M; CdSO₄ used as an active substance of Cd with a concentration of 1M to 3M; or
the HI used as the iodine-based active substance with a concentration of 1M to 6M; at least one of NaBr, KBr, NaCl, and KCl used as the Br⁻ and/or Cl⁻ source additive with a concentration of 1M to 3M; the H₂SO₄ used as the support electrolyte with a concentration of 2M to 4M; the CdSO₄ used as the active substance of the Cd with a concentration of 1M to 3M; or
CdI₂ used as the iodine-based active substance and the active substance of the Cd with a concentration of 0.5M to 3M; the HBr⁻ and/or the HCl used as the Br⁻ and/or Cl⁻ source additive with a concentration of 1M to 3M; the H₂SO₄ used as the support electrolyte with a concentration of 2M to 4M; or
the CdI₂ used as the iodine-based active substance and the active substance of the Cd with a concentration of 0.5M to 3M; at least one of the NaBr, the KBr, the NaCl, and the KCl used as the Br⁻ and/or Cl⁻ source additive with a concentration of 1M to 3M; the H₂SO₄ used as the support electrolyte with a concentration of 3M to 5M; or
NaI and/or KI used as the iodine-based active substance with a concentration of 1M to 6M; the HBr⁻ and/or the HCl used as the Br⁻ and/or Cl⁻ source additive with a concentration of 1M to 3M; the H₂SO₄ used as the support electrolyte with a concentration of 2M to 4M; the CdSO₄ used as the active substance of the Cd with a concentration of 1M to 3M; or
the NaI and/or the KI used as the iodine-based active substance with a concentration of 1M to 6M; at least one of the NaBr, the KBr, the NaCl, and the KCl used as the Br⁻ and/or Cl⁻ source additive with a concentration of 1M to 3M; the H₂SO₄ used as the support electrolyte with a concentration of 3M to 5M; the CdSO₄ used as the active substance of the Cd with a concentration of 1M to 3M.

7. The aqueous iodine-based battery based on the multi-electron transfer according to claim 1, comprising a positive electrode, a negative electrode, a membrane material, the positive electrolyte, and the negative electrolyte, wherein each of the positive electrolyte and the negative electrolyte is the strong acidic aqueous solution containing the Cd²⁺ and the I⁻, and the Br⁻ and/or Cl⁻ source additive is introduced into the positive electrolyte and the negative electrolyte to improve a kinetics and a reversibility of an electrochemical reaction process; the membrane material is a polymer material selected from at least one of polyethersulfone (PES), polyvinylchloride (PVC), polysulfone (PSF), polyethylene (PE), or Nafion.

8. The aqueous iodine-based battery based on the multi-electron transfer according to claim 1 comprising a single cell or a stack; wherein
a structure of the single cell comprises a positive terminal plate, a positive current collector, a positive carbon felt electrode filled with the positive electrolyte, a separator, a negative carbon felt electrode filled with the negative electrolyte, a negative current collector, and a negative terminal plate, wherein the positive terminal plate, the positive current collector, the positive carbon felt electrode, the separator, the negative carbon felt electrode, the negative current collector and the negative terminal plate are stacked in a sequential;
the stack is composed of two or more single cell circuits in series and/or parallel.

9. The aqueous iodine-based battery based on the multi-electron transfer according to claim 2, wherein in the positive electrolyte or the negative electrolyte, a molar concentration of the Cd²⁺ is from 0.5M to 3M, a molar concentration of the I⁻ is from 1M to 6M, a molar ratio of the Cd²⁺ to the I⁻ is 1:2 to 1:1, and a molar concentration of H is from 3M to 12M, respectively.

10. The aqueous iodine-based battery based on the multi-electron transfer according to claim 3, wherein the molar ratio of the Cd⁻ to the I⁻ is 1:2.

11. The aqueous iodine-based battery based on the multi-electron transfer according to claim 2, wherein during a charging process, IO⁻ generated from the I⁻ at the positive electrode forms a Cd(IO₃)₂ precipitate with the Cd⁻ in the strong acidic aqueous solution, to solve a problem of a self-discharge of the aqueous iodine-based battery based on the multi-electron transfer due to an infiltration of an oxidized charging product IO₃⁻.

12. The aqueous iodine-based battery based on the multi-electron transfer according to claim 2, comprising a positive electrode, a negative electrode, a membrane material, the positive electrolyte, and the negative electrolyte, wherein the positive electrolyte and the negative electrolyte are the strong acidic aqueous solution containing the Cd²⁺ and the I⁻, and the Br⁻ and/or Cl⁻ source additive need to be introduced into the positive electrolyte and the negative electrolyte to improve a kinetics and a reversibility of an electrochemical reaction process; the membrane material is a polymer material selected from at least one of PES, PVC, PSF, PE, or Nafion.

13. The aqueous iodine-based battery based on the multi-electron transfer according to claim 3, comprising a positive electrode, a negative electrode, a membrane material, the positive electrolyte, and the negative electrolyte, wherein the positive electrolyte and the negative electrolyte are the strong acidic aqueous solution containing the Cd²⁺ and the I⁻, and the Br⁻ and/or Cl⁻ source additive need to be introduced into the positive electrolyte and the negative electrolyte to improve a kinetics and a reversibility of an electrochemical reaction process; the membrane material is a polymer material selected from at least one of PES, PVC, PSF, PE, or Nafion.

14. The aqueous iodine-based battery based on the multi-electron transfer according to claim 4, comprising the positive electrode, a negative electrode, a membrane material, the positive electrolyte, and the negative electrolyte, wherein the positive electrolyte and the negative electrolyte are the strong acidic aqueous solution containing the Cd²⁺ and the I⁻, and the Br⁻ and/or Cl⁻ source additive need to be introduced into the positive electrolyte and the negative electrolyte to improve a kinetics and a reversibility of an electrochemical reaction process; the membrane material is a polymer material selected from at least one of PES, PVC, PSF, PE, or Nafion.

15. The aqueous iodine-based battery based on the multi-electron transfer according to claim 5, comprising a positive electrode, a negative electrode, a membrane material, the positive electrolyte, and the negative electrolyte, wherein the positive electrolyte and the negative electrolyte are the strong acidic aqueous solution containing the Cd²⁺ and the I⁻, and the Br⁻ and/or Cl⁻ source additive need to be introduced into the positive electrolyte and the negative electrolyte to improve a kinetics and a reversibility of an electrochemical reaction process; the membrane material is a polymer material selected from at least one of PES, PVC, PSF, PE, or Nafion.

16. The aqueous iodine-based battery based on the multi-electron transfer according to claim 6, comprising a positive electrode, a negative electrode, a membrane material, the positive electrolyte, and the negative electrolyte, wherein the positive electrolyte and the negative electrolyte are the strong acidic aqueous solution containing the Cd²⁺ and the I⁻, and the Br⁻ and/or Cl⁻ source additive need to be introduced into the positive electrolyte and the negative electrolyte to improve a kinetics and a reversibility of an electrochemical reaction process; the membrane material is a polymer material selected from at least one of PES, PVC, PSF, PE, or Nafion.

17. The aqueous iodine-based battery based on the multi-electron transfer according to claim 7, wherein the polymer material is a Nafion resin.
